(19) United States
(12) Patent Application Publication
(10) Pub. No.: US 2026/0075025 A1
(43) Pub. Date: Mar. 12, 2026

(54) Heterogeneous Content Management Engine And Related Systems And Methods

(71) Applicant: Oracle International Corporation, Redwood Shores, CA (US)

(72) Inventors: Jennifer Darmour, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/939,294

(22) Filed: Nov. 6, 2024

Related U.S. Application Data
(60) Provisional application No. 63/691,706, filed on Sep. 6, 2024.

(51) Int. Cl. H04L 51/216; G06F 16/383; H04L 51/56

(52) U.S. Cl. CPC H04L 51/216; G06F 16/383; H04L 51/56

(57) ABSTRACT

Techniques for heterogeneous content management are disclosed herein. Messages and other content items are managed by a heterogeneous content management engine. Content items and/or extracted features of content items are clustered by topic, source, and/or timestamp and arranged in navigable content item histories for clusters. Assets related to content items are generated and presented in accordance with the content items. Interaction with content items of the history results in generation of content item history or detailed view for the content item. Whan a user interacts with assets, interfaces for corresponding detailed views, item histories, or work items are related to the asset are provided to the user.

### INCORPORATION BY REFERENCE; DISCLAIMER

Each of the following applications are hereby incorporated by reference: Application No. 63/691,706 filed on Sep. 6, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to a heterogeneous content management engine and related systems and methods. In particular, the present disclosure relates to managing and/or arranging heterogeneous content items of a system using the heterogeneous content management engine.

### BACKGROUND

Message centers are centralized platforms designed to facilitate communication across various sources, such as emails, short message service (“SMS”), social media posts, instant messaging, internal communication tools, forums, and the like. In contrast, data centers are often used to store various non-message content items. For instance, document centers provide interfaces that aid in the organization and retrieval of documents.

Techniques in this disclosure may address the aforementioned flaws, challenges, and difficulties by providing techniques that result in improved heterogeneous content management. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example heterogeneous content management engine system in accordance with one or more embodiments;

FIG. 2 illustrates an example set of operations for a heterogeneous content management engine in accordance with one or more embodiments;

FIGS. 3A-C illustrate example graphical user interfaces for a heterogeneous content management engine in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE HETEROGENEOUS CONTENT MANAGEMENT ENGINE SYSTEM
3. EXAMPLE OPERATIONS FOR A HETEROGENEOUS CONTENT MANAGEMENT ENGINE
4. EXAMPLE GRAPHICAL USER INTERFACES FOR HETEROGENEOUS CONTENT MANAGEMENT ENGINE
5. COMPUTER NETWORKS AND CLOUD NETWORKS FOR HETEROGENEOUS CONTENT MANAGEMENT ENGINE
6. MICROSERVICE APPLICATIONS FOR HETEROGENEOUS CONTENT MANAGEMENT ENGINES
7. HARDWARE OVERVIEW
8. MISCELLANEOUS; EXTENSIONS

Message centers facilitate users accessing and viewing messages to and from the user. Messages centers typically include some sorting and/or searching features. For example, many email services include a message center that serves as a searchable and sortable mailbox for emails. In general, various types of documents or other files are often also accessed and/or viewed by users that are not a part of a message center.

Documents and other files are typically stored in various storage systems. In cases where the documents or other files are uploaded for shared access, the documents or other files are typically accessed or viewed using an application separate from the message center application. A separate application is required to be used or plugged into a message center application to enable accessing non-message content items.

Integrating messages and non-message content items presents numerous challenges. Large systems with diverse content items, containing distinct attributes and features, add significant complexity to content management. Effective techniques are needed to organize heterogeneous content items, such as in the case of when content items include both messages and non-message content items and/or when content items of different types are associated with multiple topics or diverse data formats.

One or more embodiments cluster and sort a heterogeneous set of content items including both messages and non-message content items for integrated presentation in a GUI. A heterogeneous content item management engine, as discussed herein, facilitates arranging, displaying, grouping, ordering, creating, removing, and/or changing associations and relationships between heterogeneous content items and/or attributes associated with the heterogeneous content items. For example, the heterogeneous content item manager creates clusters of content items and arranges the content items based on a shared topic, source, and/or temporal proximity. The heterogeneous content item manager also generates assets for the clusters and presents histories or timelines of content items with the assets. The system displays a chronological arrangement of heterogenous content including both messages and non-message content.

In an embodiment, messages are stored in association with corresponding timestamps such as the time sent or time received. Furthermore, assets, such as a test result, chart, completed response form, or other documents, are also stored in association with timestamps corresponding to date/time of creation, or date/time of transmittal. Furthermore, messages and non-message content items are associated with tags or labels indicating sources, and/or topics. Using the timestamps and the one or more associated tags or labels, both messages and non-message content items are clustered using a weighting and/or scoring determined from the timestamps and the one or more associated tags or labels. Heterogeneous content items within a cluster are arranged and displayed based on the timestamps, sources, and topics.

In one example, a heterogeneous content item management engine is used for managing messages. For example, in the context of a medical practice, messages are sent between doctors, nurses, and patients. For a topic corresponding to a patient's condition or illness, portions of related messages, test results, summaries, charts are displayed in heterogeneous, ordered, navigable interfaces.

While this General Overview section provides a general overview additional embodiments and related combinations of features may be described in this Specification and/or recited in the claims outside of this General Overview section.

### 2. Example Heterogeneous Content Management Engine System

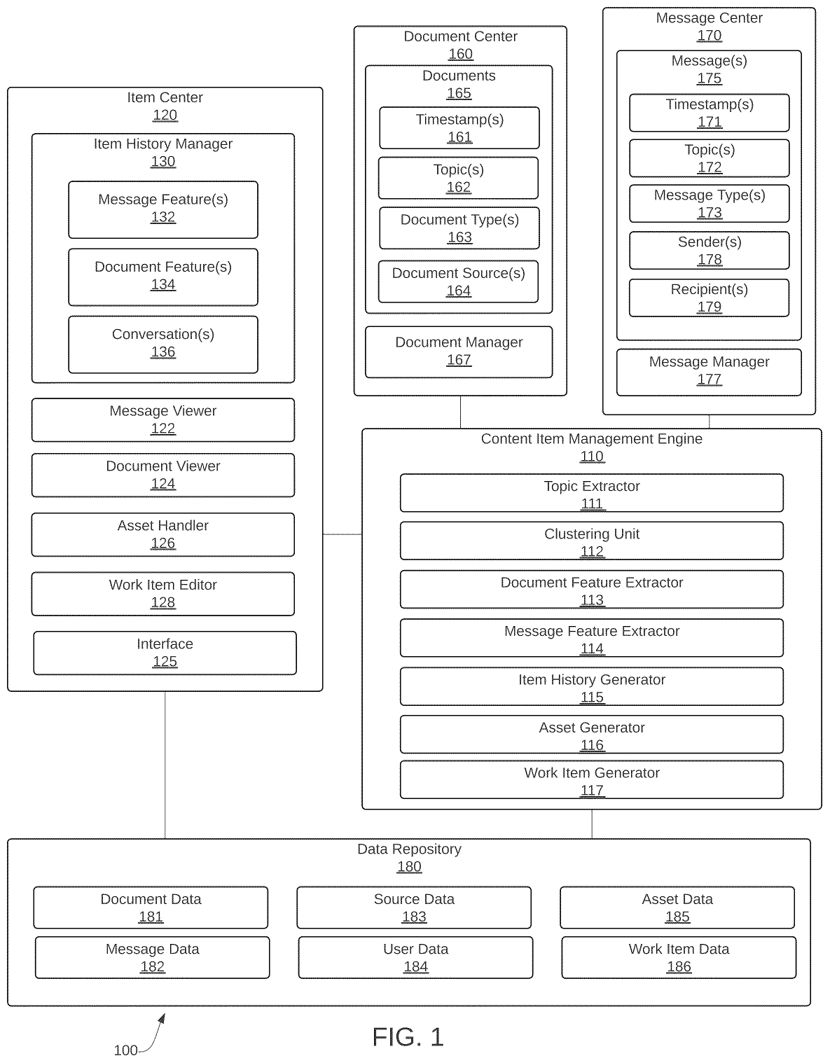

FIG. 1 illustrates an example system 100 for heterogeneous content management using content item management engine 110 in accordance with one or more embodiments. As illustrated in FIG. 1, system 100 includes the content item management engine 110, an item center 120, a document center 160, a message center 170, and a data repository 180. In various embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In FIG. 1, the content item management engine 110 includes a topic extractor 111, a clustering unit 112, a document feature extractor 113, a message feature extractor 114, an item history generator 115, as asset generator 116, and a work item generator 117. The content item management engine 110 processes and/or manages various types of content, such as message and non-message content item, like documents or other items.

The topic extractor 111 identifies the main themes or subjects within a piece of content. The topic extractor includes templates or language models used to identify a primary topic, one or more secondary topics, one or more related topics, or one or more included topics.

The clustering unit 112 groups similar content items together, allowing for better organization and retrieval; for example, the clustering unit determines clusters of content items based on shared topics. The clustering unit also determines clusters of content items related to conversations. The clustering unit also determines clusters of content items based on temporal proximity. In various embodiments, the clustering unit includes various clustering algorithms that generate clusters based on a weighted scoring of topics, timestamps, sources, and/or other criteria.

The document feature extractor 113 includes modules that extract portions of documents to create content items based on the extracted portions. For example, an example document includes charts, test results, a summary, and a date. The document feature extractor includes templates or recognition algorithms that select and/or extract portions of the document based on particular attributes of the features. In various embodiments, the particular attributes are a topic or topical correlation value to a topic, a timestamp or temporal correlation value to a time, and/or a source, sender, or recipient. In some cases, portions of a message or document are extracted by using language processing to determine that one or more sections of the message or document contain text having a particular topic as a primary topic, including the particular topic, or including a primary topic related to the particular topic.

The message feature extractor 114 includes modules that extract portions of messages. For example, an example message includes a sender, a recipient, a timestamp, and a body of text. The message feature extractor includes templates and/or language models that extract the sender, recipient, and/or timestamp. The message feature extractor includes templates and/or language models that determine a set of topics associated with a message or with particular portions of a message. The language model identifies message portions related to a particular topic for topic-based extraction.

The item history generator 115 generates an item history using the extracted features of messages and documents. For example, the item history generator includes modules for an item history such as for display in a GUI. For a particular topic, the item history generator 115 arranges features extracted from messages and documents related to the particular topic in a timeline. In embodiments, the item history generator 115 includes modules for generating a GUI from a cluster of content items and/or features of content items related to a particular topic and/or client.

The asset generator 116 includes modules for generating one or more assets used by the system 100. The modules include templates and/or models that are triggered according to various triggering conditions. One example triggering condition is co-inclusion of an action item, work item, document, and/or feature in a cluster with a particular item using certain parameters for the cluster as further described below. The asset generator 116 generates assets for item views and item detail views of item histories generated by the item history generator 115.

One example of the asset generator 116 includes a module for generating an action item asset in response to a triggering condition. The asset is generated in response to a target of the action item being included in a cluster for a primary topic. For example, a suggestion of a related topic, document feature, or message feature is presented in response to the topic and/or feature being included in a cluster with the primary topic.

Assets are also generated automatically in response to a determination that one or more particular documents have been received by the content management engine 110. For example, an asset for a work item is generated automatically in response to one or more documents and/or one or more messages, indicating generation of the work item being received. In one example, an asset is generated such that if the asset is interacted with, the system automatically generates a work item. In an example, the management engine 110 automatically drafts a message (such as an email) summarizing test results, diagnosis, charts, referrals, recommendations, and/or other event details associated with a patient visiting a hospital in the form of a work item. The work item is automatically presented to a medical practitioner for review and delivery to the patient.

Other assets are generated indicating that a particular message feature shares a topic, indicating that a particular document feature shares a topic, that the system has generated a document or document feature, and/or that the system has generated a work item.

Work item generator 117 includes templates language models and/or logic for generating at least partial work item drafts. For example, based on a trigger, an at least partial work item is drafted. In various embodiments, a work item is automatically generated in response to one of the following triggers: a document type being present in the system; a value of an attribute read from a document in the system exceeding a threshold value; and/or a statement related to the work item being present in a message received by the system. At least partial work items are stored so that a user can edit and/or complete the draft work item. For example, the work items are saved in a word processing file format and edited using a word processor.

As illustrated in FIG. 1, the item center 120 includes one or more viewers and or interfaces for displaying and/or otherwise presenting content. In the example, the item center 120 includes an item history manager 130, a message viewer 122, a document viewer 124, an asset handler 126, a work item editor 128, and an interface 125.

The item history manager 130 presents, loads, requests, and/or otherwise manages item histories such as those generated by item history generator 115. For example, the item history manager presents one or more message features 132, document features 134, and/or conversations 136.

A message feature 132, in general, refers to a section or portion of a text that is associated with a particular topic, source, sender, timestamp, type, recipient, and/or cluster membership. Likewise, a document feature refers to documents of various types that are associated with a particular topic, source, timestamp, type, and/or cluster membership. Features of messages and features of documents are extracted arranged into conversations 136. Conversations 136 include timelines of extracted message and/or document content related to a particular topic and/or subject.

The item center 120 also includes a message viewer 122, document viewer 124, an asset handler 126, a work item editor 128, and an interface 125.

The message viewer 122 includes various features. For example, user selection of an active portion of text displayed via the message viewer causes a change in a selected topic. In embodiments, one or more assets are presented based on the selected topic. Also, in embodiments, one or more other portions of text and/or other content items are provided with a visual indicator based on having a shared topic with the selected topic.

Likewise, the document viewer 124 includes various features. For example, user selection of an active portion of the document viewer causes a change in a selected topic. In embodiments, one or more assets are presented based on the selected topic. Also, in embodiments, one or more other portions of text and/or other content items are provided with a visual indicator based on having a shared topic with the selected topic.

Asset handler 126 includes controls and modules related to presenting assets. In general, assets refer to visual indicators providing links to various content items. The assets include various components. The components in embodiments include but are not limited to, links to other interfaces or executables. User interaction with an asset results in navigation to an interface for viewing content item histories, for viewing content items related to a particular items, or for editing draft work items or messages.

Work item editor 128 includes controls and modules (such as a word processor) related to presenting and/or editing work items. In general, work items refer to text content or form content that is generated based on one or more features of messages and/or documents, for example, by generating a draft message to a recipient or by generating a draft form using contents of a message and/or document.

Generally, interface 125 refers to hardware and/or software configured to facilitate communication between a user and a system, as described further below.

In various embodiments, the document center 160 stores, provides access to, and/or manages various documents. Examples of different documents include medical event records and related documents (e.g., records for doctor's visits, treatments, hospitalization events, insurance documents, referrals, test results, patient charts, treatment and/or medication orders, transaction histories, or the like). In the example, documents in the document center include one or more timestamp 161, topics 162, document types 163, and/or document sources 164. The document center of some embodiments also includes a document manager 167. Generally, document centers provide a feature rich environment for managing and/or accessing documents, and the document manager 167 is suitable for performing such features. In various embodiments, the document center includes different files and/or documents that are accessible to the system 100. In embodiments, the document center 160 is separate from the message center 170.

In general, a timestamp 161 for a document can be generated for when the document is created, saved, or modified. A timestamp can also be created for a document that represents a date and/or time for which contents of the document were created. For example, a document that includes a test result can include a timestamp for when the test was performed and/or ordered, when the results were obtained, and/or when the results were saved to a document management system.

In various embodiments, documents can be tagged or associated with one or more topics 162. Topics can be determined by a title. Also, topics can be determined by according to defined associations between the topic and the type of the document. For example, a document that is a blood pressure test result is associated with topics related to heart conditions, such as hypertension or arrythmia. A document that is a doctor visit or hospital summary includes topics noted in the summary and/or related to topics noted in the summary.

In various applications of this disclosure, documents have various types 163. Examples include medical event records and related documents (e.g., records for doctor's visits, treatments, hospitalization events, insurance documents, referrals, test results, patient charts, treatment and/or medication orders, transaction histories, and the like, as discussed above). In various embodiments, documents include text documents, audio files, video files, JavaScript object notation (“JSON”) format files, particular file formats for measurement and/or control instruments, and/or other file formats or combinations of formats that may include structured and/or unstructured data.

In embodiments, a document also includes one or more sources 164. For example, a test result that is an x-ray ordered by a doctor and performed by a radiologist includes the doctor and/or the radiologist as the one or more sources.

In various embodiments, the message center 170 stores, provides access to, and/or manages various messages, such as email, text messages, instant messages, direct messages, transmitted conversations, message threads, forum posts, and/or the like. One or more messages 175 includes one or more timestamps 171, topics 172, message types 173, senders 178, and/or recipients 179. The message center includes a message manager 177. The message manager 177 is a tool or interface that allows users to view, organize, and manage messages from various sources in a unified manner. Viewers provide functionalities for reading, categorizing, searching, and sometimes responding to messages, offering a streamlined way to handle large volumes of communication. A message viewer can also include editing features. Examples include email clients, social media dashboards, customer support systems, public forums, instant messaging applications, etc.

The one or more messages 175 generally refers to individual pieces of communication, such as emails, text messages, or message board, forum, or social media posts. Messages contain several component features that are extractable, such as topic, type, timestamp, sender, and/or recipient.

Timestamps 171 indicate the date and time when the message was sent or received. A timestamp 171 can also be created for a message that represents a date and/or time for when the message and/or its contents was created. For example, a message that includes an attached test result can include a timestamp for various features. Various types of timestamps include, but are not limited to, timestamps for when the message was sent, when a test referenced in the message was performed and/or ordered, when the results were attached to the message, and/or a date or time mentioned in the message.

Topic(s) 172 refer to the main subjects or themes discussed in the messages. For example, in a customer support context, topics could include “billing issues,” “technical support,” or “product inquiries.” In the context of a medical diagnosis, example topics could include “diabetes” or “heart disease.” Topic identification is performed by various templates and/or machine learning models.

In general, the message type(s) 173 describe the nature or category of the message. This could include a description differentiating between types, such as a message from a user sender to a client recipient, a message from a user sender to a user recipient, message posts to a message board or other storage location, or the like.

The message sender(s) 178 refer to the individuals or entities that originate the messages 175. This refers to the originating entity and/or platform from which the message was sent. In an example embodiment, the message sender(s) 178 includes a sender who is a doctor and includes a doctor identification, a doctor address, a hospital address, and/or other sender information.

The message recipient(s) 179 are the individuals or entities to whom the messages are addressed. Continuing the example embodiment, an example recipient 179 is a patient and includes a patient identification, a patient address, patient information, insurance information, other recipient information, and/or the like.

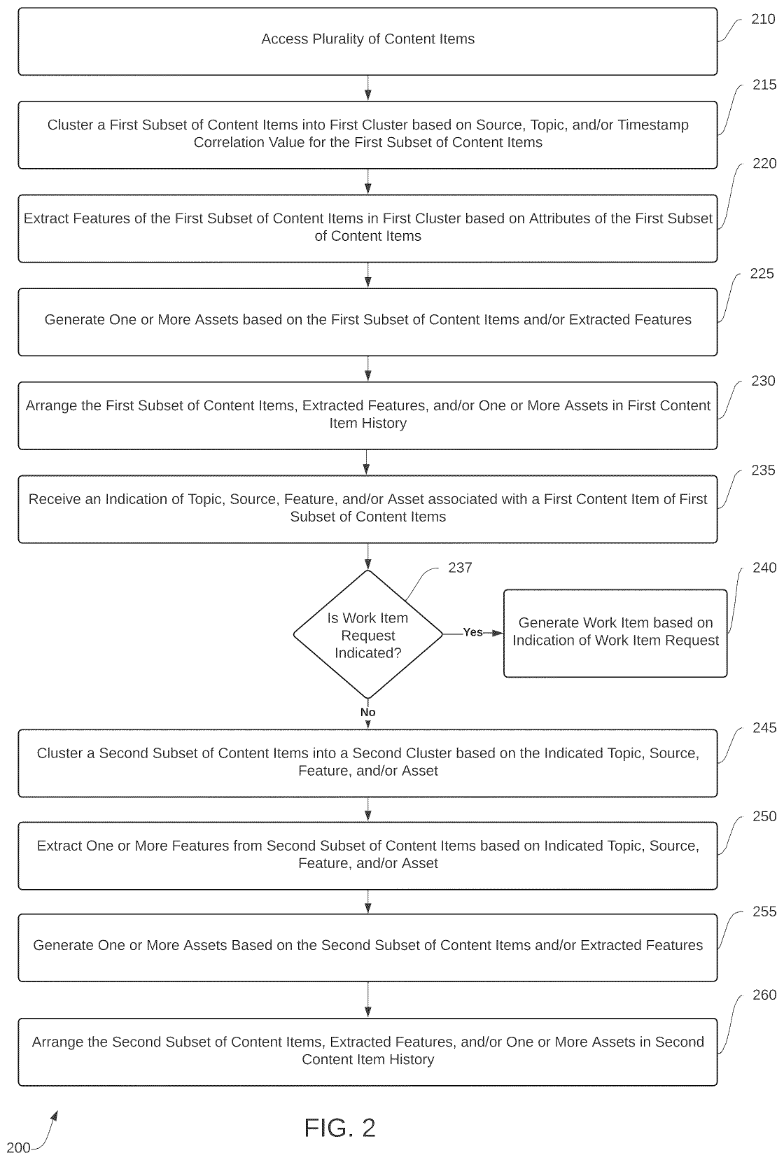

Examples of operations for heterogeneous content management performed by the system 100 are described below with reference to FIG. 2.

In an embodiment, the heterogeneous content management system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, an interface refers to hardware and/or software configured to facilitate communication between a user and a system. In FIG. 1, an interface 125 is used to facilitate communication between the item center 120, the content management engine 110, and/or one or more client computing devices. Such an interface renders user interface elements and receives input via user interface elements. Examples of interfaces include a graphical user interface (“GUI”), a command line interface (“CLI”), a haptic interface, and a voice command interface. Examples of user interface elements include checkboxes, radio buttons, dropdown lists, list boxes, buttons, toggles, text fields, date and time selectors, command lines, sliders, pages, and forms.

Generally, the data repository stores data loaded onto the data repository from the content item management engine 110 and/or the item center 120, the document center 160, and/or the message center 170. The data repository 180 in embodiments also stores data loaded into the data repository from other sources. In various embodiments, the data repository stores one or more types of data including, but not limited to, document data 181, message data 182, source data 183, user data 184, asset data 185, and/or work item data 186.

Without limitation, document data 181 includes data, such as discussed with reference to the document center 160 and/or other content item data. Message data 182 includes data such as discussed with reference to the message center 170.

By way of example, source data 183 includes stored data about or related to a particular source. Source data 183 includes location information, contact information, and other data associated with data sources. User data 184 includes stored data about or related to a particular user. User data 184 includes data, such as location information, contact information, and other data associated with users.

Asset data 185 includes data associated with various item interfaces that are presented to the user. For example, asset data 185 includes data related to icons, fonts, backgrounds, or other features of GUIs. The asset data 185 also includes configurations, templates, and/or other data related to storing triggering conditions for presenting and/or generating assets. In embodiments, asset data 185 includes data containing templates, logic, and/or triggering conditions determining when and how assets are generated, presented, scored, and/or ranked.

Work item data 186 includes data related to work items that are generated and/or received by the content item management engine 110 and/or otherwise loaded onto the data repository 180. In embodiments, work item data 186 is accessed by the work item generator 117 to generate draft work items. In embodiments, work item data 186 includes template data for generating draft work items.

In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

### 3. Example Operations for a Heterogeneous Content Management Engine

FIG. 2 illustrates an example set of operations for heterogeneous content management in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In the example, the system accesses a plurality of content items (Operation 210). In various embodiments, content items are accessed from a data repository, a message center, a document center, or another data source. For example, content items that are messages are accessed from a message center, such as an email client, a forum, or a message database. Content items that are non-message content items are accessed from a data source other than a message center. For example, content items that are non-message content items are accessed from a medical record database, a file transfer protocol (FTP) database server, a file management system, another file system, or another non-message data source.

The system clusters a first subset of content items into a first cluster based on source, topic, and/or timestamp correlation values for the first subset of content items (Operation 215). The system clusters sets of content items by analyzing and comparing sources, topics, and timestamps. Values are assigned to features of the content items, such as the source, the central topic or themes, and the time of creation or receipt. The system then uses algorithms, such as k-means or hierarchical clustering, that consider the correlation values between different features. These correlation values indicate how closely related the items are based on the chosen attributes.

By assigning different weights or parameters to the source, topic, and timestamp, the system can select features based on various attributes to generate assets of a particular type and/or organize a content item history in a particular way. In an example, the system weights the various topics, sources, and/or timestamps relatively more or less depending on an indication from a user. This flexibility in weighting allows the system to dynamically adjust the clustering process, resulting in clusters of content items that are used for generating assets and/or content item histories for a particular topic, source, or timeframe. In some embodiments, clustering the plurality of content items comprises clustering content items into the first cluster based on a minimum score for a minimum topical correlation value and/or a minimum temporal correlation value for the first content item and the second content item.

User indication of a particular feature of a content item, such as a user clicking on a visual indication of a topic or source, results in clustering using increased weighting for the indicated feature. In this way, a user is able to select a topic, source, sender, time period, type, or other feature of a presented content item, and as a result, the feature will be given a higher weight for a subsequent clustering. The system then generates a new content item history using a subsequent cluster. This feature facilitates generation of clusters and item histories that are generated based on user indication of desired clustering parameters.

In some embodiments, responsive to a message content item in a cluster referencing a non-message content item, the non-message content item is added to the cluster. In some cases, responsive to a threshold number of references to a particular non-message content item being present in one or more message content items and/or other non-message content items, the particular non-message content item is added to the cluster.

The system extracts features of the first subset of content items in the first cluster based on attributes of the first subset of content items (Operation 220). In one example, segments or portions of messages that are sections of text that include respective sets of topics for the sections of text are extracted as features of the content items. In another example, features of documents are extracted based on the feature having one or more primary topics associated therewith and/or one or more related topics associated therewith. In various embodiments, features are extracted using templates, linguistic processing, and/or based on manually defined filters or other criteria.

In various embodiments, extracting features from documents based on source, type, or topic involves several steps and techniques, such as use of natural language processing (NLP) and machine learning algorithms to process textual features. When analyzing documents, text and/or other elements of the document are preprocessed and/or tokenized, where the text or other element is divided into individual tokens. For feature extraction, one approach is to use term frequency-inverse document frequency (TF-IDF) that highlights the importance of words in a document relative to a corpus. This method helps identify key terms that are significant for a particular source, type, or topic. Another approach is using word embeddings, such as Word2Vec or GloVe, that transform words into continuous vector spaces, where semantically similar words are closer together. Document features can also be extracted using more advanced methods, like topic modeling, that identify hidden themes within a document collection. Latent Dirichlet Allocation (LDA) is a topic modeling technique that assigns probabilities to words belonging to specific topics, thereby categorizing documents by their predominant topics.

When extracting portions of different types of messages, the process varies slightly. For instance, in emails, features like the sender, recipient, timestamp, subject line, and body text are features of the emails. In social media posts, metadata, such as user handles, hashtags, and mentions, along with the post content itself, are features of the social media post. Techniques like Named Entity Recognition (NER) identify and categorize entities like names, dates, and locations within the text.

Additionally, the context and structure of the message play significant roles in feature extraction. For structured text, the extraction is based in part on the structure of the text. For unstructured text, algorithms like recurrent neural networks (RNNs) or transformers (e.g., bidirectional encoder representations, generative pretrained transformers) are used to capture contextual relationships between words and sentences, enabling more accurate extractions based on sources, types, or topics of messages.

The system generates one or more assets based on one or more content items of the first subset of content items (Operation 225). In various embodiments, one or more content items, one or more features of the content items, and/or one or more templates, stored logic, images, or other data accessible to the system are used to generate various assets. The assets provide navigation to content related to a particular content item in an interface adjacent to the particular content item. The assets present features of related content items and/or labels describing the content items, content item (or feature) relationship, and/or asset type.

In an example, various assets are generated based on one or more content items belonging to a same cluster as a first content item and/or being mostly closely clustered. Measuring closeness, or similarity, during clustering involves using various distance metrics and similarity measures to group content items with similar characteristics. Methods include Euclidean Distance, Manhattan Distance, Cosine Similarity, Jaccard Index, Pearson Correlation Coefficient, etc. These measures calculate the closeness between content items, allowing the system to group similar items into clusters based on their features (e.g., a set of one or more topics, timestamps, entities, attributes, scores, other metrics, etc.).

Various similarity scores are deployed in various embodiments. For instance, two articles might be close in terms of topic similarity using Cosine Similarity, while another pair of articles might be close in terms of publication date using Euclidean Distance on their timestamps. The system assigns scores to these similarities, reflecting the degree of closeness for the criterion. By weighting these scores, the system makes a selection of assets to be generated and/or presented based on a greatest topical relevance and/or other triggering condition. For example, an asset for a most closely clustered document is generated. An asset for a most closely clustered message or conversation is generated. An asset for a work item is generated. An asset for a patient profile is generated. An asset link to a summary of one or more messages and/or document is generated. One or more other assets are generated. In the example, an asset is generated in the form of a link, icon, popup, button, or the like that is presented adjacent to the message content in the content item history.

For example, a first message having a primary topic is included in an ordered list of content items such as a content item history. Subsequent messages are presented after the first message in the timeline. The subsequent messages are presented based on being related to the primary topic of the first message. One or more assets are generated based on one or more documents being included in the same cluster as the first message and/or based on having the primary topic as a topic of the document (or feature of the document). For example, in a content item history that is ordered chronologically, the document with the highest correlation value to a selected content item is determined by a clustering algorithm. Although the document may be spaced apart from a selected or first content item in the history due to other content items having timestamps between the timestamp of the selected content item and the timestamp of the document, an asset is generated for the document based on a highest correlation value between the document and the selected content item, and the asset is presented adjacent or proximate to the selected or first content item.

In various embodiments, content items and/or features are represented as vectors. Clustering algorithms such as K-means, hierarchical clustering, density based spatial clustering scan, and/or other techniques are employed to group similar content items into clusters. These algorithms analyze the feature vectors and group content items based on their similarities, forming clusters where items within the same cluster are more similar to each other than to those in different clusters.

To identify the closest clustered content item to a particular content item, a similarity measure, such as cosine similarity or Euclidean distance, is used. This involves calculating the distance or similarity between the vector representation of the target content item and the vectors of other items within the same cluster. The content item with the highest similarity (or the shortest distance) to the target item is considered the closest clustered content item. By adjusting weights of parameters used for clustering, content items having particular relationships are identified.

Once a closest clustered content item is identified, an asset is generated for it. The nature of this asset depends on the application but could include summarizing the content, extracting key insights, creating a recommendation, or generating a related visual or multimedia element. The generated asset type is provided with the asset in the form of a label and/or icon describing the relationship of the closest clustered content item. For example, a label might indicate “explore topic X,” “see message dated Y,” or “view test result Z.” This process leverages the semantic similarity and contextual relevance of the closest clustered content item to enhance the value of the target content item by providing outputs based on the closest match within one or more clusters.

In embodiments, the system generates assets automatically in response to a trigger or logical condition. For example, language processing of a message content item is used to determine that a message includes a phrase indicating that a work item will be ordered or is otherwise intended to be generated based on the indicating phrase. An example is as follows: a doctor indicates in a message to a nurse that a work item is to be ordered. In this example, an asset is generated based on this indication in the message. Various example work items include prescription orders, appointment requests, referral orders, test requests, and/or other items. User confirmation is received by the user clicking an action button. Confirmation results in the work item being at least partially generated by the system and presented to the user.

In another example, the system uses document analysis to determine that a work item asset is to be generated automatically based on the content of the document. For example, a document that is a test result is analyzed to determine that a subsequent test is to be ordered based on a trigger or logical condition. Continuing this example, based on a test result meeting a criterion, a work order asset or message asset is generated. For example, one or more assets are generated and presented adjacent to the document based on the content of the document. The asset is presented to the user as a confirmation as to whether a draft work item should be automatically generated.

When a user interacts with an asset of the one or more assets, a resulting action occurs. For example, an order or referral for a subsequent test or prescription is at least partially drafted and/or a message summarizing the document is at least partially drafted, and/or another work item is drafted.

The system arranges the first subset of content items, extracted features, and/or one or more assets in a first content item history (Operation 230). The content items, extracted features, and/or assets are arranged based on a source, topic, and/or timestamp for the first subset of content items. The system arranges the first subset of content items with the one or more features and the one ore more assets in a timeline in the first content item history.

For example, for a particular topic, content items are arranged in a timeline according to timestamps for the content items. The content items are arranged with a source indicator, such as a label or coloring, indicating the source. The content items are arranged temporally in a timeline with source indicators and/or visual indicators for features of the content items sharing a common topic. Sources and timestamps are used to determine conversations and/or threads related to a particular topic. For example, for a topic “diabetes” for a particular patient, conversations of messages about diabetes are arranged in a timeline with source indicators indicating the senders of the messages. Non-message content items are also arranged in the timeline. The timeline optionally includes indications of the sources of the non-message content items. The content items are selectable by a user based on the user indicating one or more subjects, sources, topics, and/or the like.

The system receives an indication of a topic, source, feature, and/or asset associated with a first content item of the first subset of content items (Operation 235). In various examples, the first subset of content items is presented to the user in various forms. In a particular example, a user is presented a timeline of the first subset of content items in which the content items for a topic are arranged according to timestamp. A user indicates a feature of a content item of the timeline by clicking or otherwise interacting with the content item. For example, a user indicating a source, topic, timestamp, or other feature for a content item results in an explorable detail view being displayed for the content item. In another example, a user indicating a topic other than a primary topic of the first cluster results in the system performing a second clustering using the indicated topic. In this case, another content item history timeline for the indicated topic is generated and presented.

The system determines if a work item request is indicated (Operation 237). Generally, a work item asset is presented to a user responsive to a triggering condition being detected by the system. User selection of the work item asset indicates and/or confirms that a work item is to be drafted.

If a work item is indicated, a work item is generated based on the indication of the work item (Operation 240). For example, an asset may present a label indicating a “draft” function and a work item type (e.g., “draft order,” “draft prescription,” or “draft email”) with an associated icon. In response to an interaction with a button for the work item asset, a draft work item is generated, and/or a work item editor interface is opened for editing the draft work item. In embodiments, if the system does not determine that a work item is indicated, a work item is not generated.

The system clusters a second subset of content items into a second cluster based on the indicated topic, source, and/or feature (Operation 245). In various embodiments, subsets of content items are grouped into clusters based on matching a topic or source of the indicated topic, source, or feature. For example, a user indicating a particular source of a content item results in clustering a subset of content items into a cluster based on the content items matching the particular source. In another example, a user indicating a particular content item or a particular feature of a content item results in clustering a subset of content items into a cluster based on the content items matching a primary topic associated with the particular content item or a particular feature of the content item. In another example, a user indication results in the system clustering a subset of content items based on topics of the subset having a high topical correlation value with one or more topics associated with the user indication. In yet another example, a user indicates a content item having a timestamp associated with the content item, and the system clusters a set of content items based on temporal proximity or temporal correlation with the associated timestamp.

The system extracts one or more features from the second subset of content items (Operation 250). Generally, a selected topic is determined from the user indication of a topic, source, and/or feature. For an indicated topic, the selected topic is the indicated topic. For an indicated source or feature, the selected topic is the primary topic associated with the content item for which the source or feature is indicated. In embodiments, the features of the second subset of content items having the selected topic as a primary topic are extracted from the second subset of content items.

For example, a user is presented with a timeline of conversations about their medical history. The user indicates a selection of a chart. The primary topic for the chart becomes the selected topic. Features of the second subset of content items having the selected topic as a primary topic are extracted from the second subset of content items. A message content item includes a plurality of sections related to a plurality of topics. One or more sections related to the selected topic are extracted from the message content item.

The system generates one or more assets based on the second subset of content items and/or extracted features (Operation 255). For example, a content item is a closest content item to an indicated content item in the second cluster. An asset for the closest content item is generated in response to the content item being the closet. An asset for a content item is generated in response to various triggers, such as threshold closeness, cluster membership, correlation values, etc. In embodiments, assets are generated based on a type of item indicated. For example, if a content item having a new primary topic is indicated, assets related to the new topic and a new content item history are generated and/or presented related to the new topic. If a feature of a content item is indicated, assets related to a primary topic for the feature are generated and/or presented proximate the feature in a current content item history.

The system arranges the second subset of content items, extracted features and/or one or more assets in a second content item history (Operation 260). In embodiments, the system arranges one or more extracted features of the second subset of content items within the content item history based on sources and/or timestamps for the one or more extracted features. In some embodiments, the content item history is generated by arranging features extracted from the second subset of content items in a timeline by relevance, conversation, thread, source, and/or timestamp. The second content item history is generated by arranging the second subset of content items in a timeline by conversation, thread, source, and/or timestamp. The system selects the relevant features of content items that need to be included in the history. For instance, if the items are to be arranged by topic, the system groups message portions related to the topic that are part of the same discussion. When arranged by source, the system categorizes the items based on their origin, grouping items from the same source together.

Once these features are extracted, the system organizes them within the content item history according to various criteria (e.g., sources, senders, and/or timestamps). In embodiments, the system places the features, items, threads, and/or conversation in chronological order in a history or timeline. The history or timeline includes item summaries and/or other assets near to the timeline. For example, document icons or summaries are placed alongside the timeline in a location based on common cluster membership and/or timestamp. For instance, if the arrangement is based on topic, the features are ordered chronologically in a timeline for the topic. The content items are optionally arranged with visual indicators or groupings for sources or senders. If the arrangement is based on source or sender, the system arranges the content items in a timeline for the source or sender, optionally with visual indicators or groupings for one or more topics.

### 4. Example Graphical User Interfaces for Heterogeneous Content Management Engine

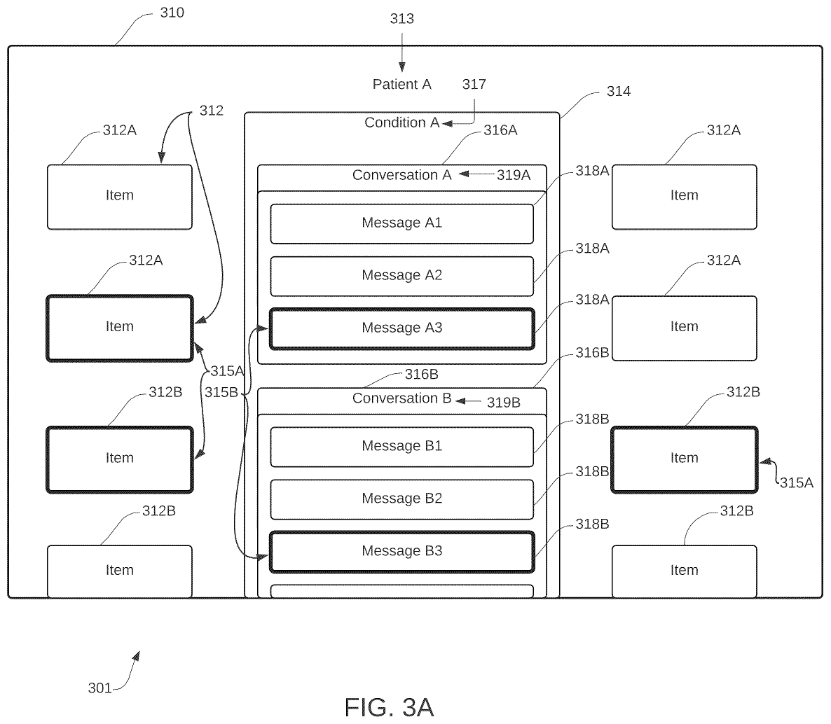

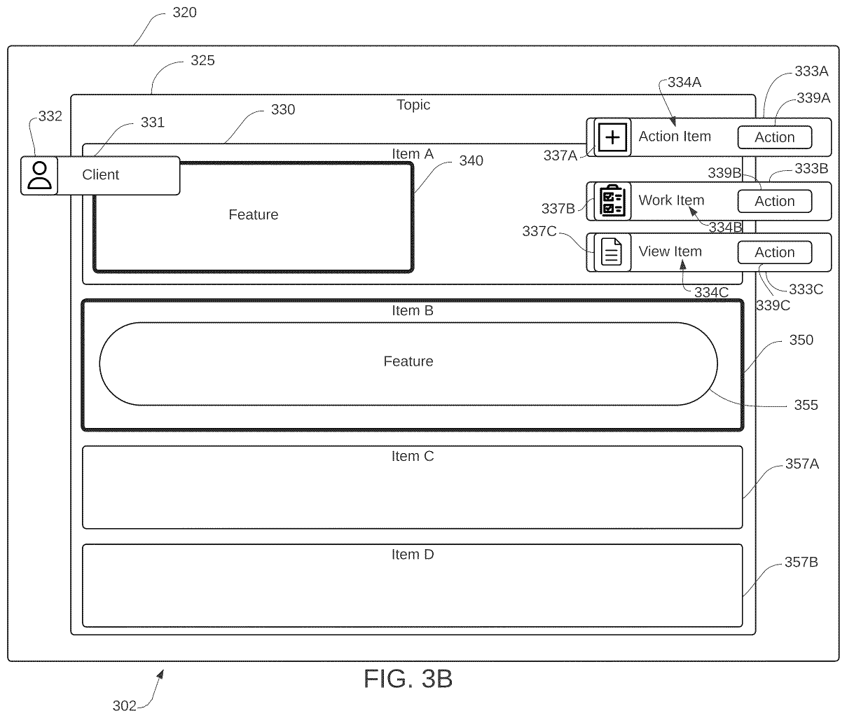

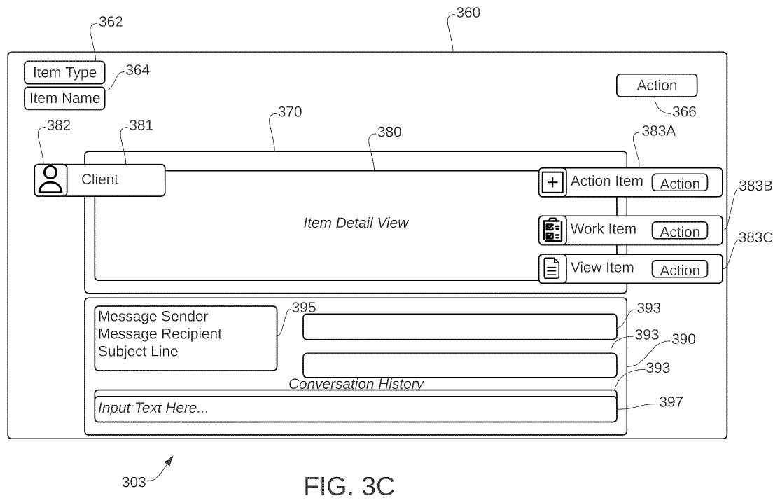

FIGS. 3A-C illustrate example GUIs for a heterogeneous content management engine in accordance with one or more embodiments.

FIG. 3A illustrates a first GUI 301 for a heterogeneous content management engine. In FIG. 3A, a first GUI element 310 includes one or more item graphical interface elements 312 and a conversation history interface element 314.

In the example, the conversations in the first GUI element have a primary topic and/or subject. A subject label 313 displays a name or label for the particular subject (Patient A in the example) in the first GUI element 310, proximate the top center. A topic label 317 displays a topic identifier or label for the particular topic (Condition A in the example) that is related to a particular topic for the particular subject in the conversation history. The topic label 317 is presented in the conversation history interface element 314 proximate a top center of the conversation history interface element 314, below the subject label 313 in the example.

The one or more item graphical interface elements 312 are arranged around the conversation history interface element 314 in the first GUI element 310. The conversation history interface element 314 is scrollable and provides a scrollable timeline of conversations (e.g., Conversation A, Conversation B, Conversation C, and so forth). In various embodiments, the conversations are arranged in a timeline based on a threshold closeness to a primary topic and/or based on being the conversation being a member of a particular cluster having the primary topic (Topic A, in the example) as a topic of the cluster. As the user scrolls and/or selects messages, the conversations, items, and/or visual indicators scroll and/or otherwise change accordingly.

One or more conversations having the particular topic as a topic of the conversation are organized temporarily according to timestamps and/or sources for messages contained within the one or more conversations. In the example, a first conversation, conversation A, is displayed in a first conversation GUI element 316A, and a second conversation, conversation B, is displayed in a second conversation GUI element 316B. A first conversation label 319A a displays a name, identifier, or label for the first conversation, and a second conversation label 319B displays a name, identifier, or label for the second conversation. The first conversation is presented as a timeline of messages 318A in the first conversation GUI element 316A, and the second conversation is presented as a timeline of messages 318B arranged in the second conversation GUI element 316B. In the example, two conversations having three or more messages are shown. However, in practice, any number of conversations having any number of messages may be displayed.

In the example, one or more item GUI elements 312 are included in the first GUI element 310. In FIG. 3A, first conversation items 312A are arranged alongside the conversation history interface element 314. In FIG. 3A, items 312A are arranged proximate or alongside the first conversation, shown in element 316A due to being temporally proximate (e.g., within a timeframe of the associated conversation, Conversation A) to the first conversation, whereas items 312B are arranged proximate or alongside the second conversation.

Also in the example, item visual indicators 315A and message visual indicators 315B are presented based on the corresponding item or message having a shared topic corresponding to a selected message or item. For example, user selection of a particular message or item causes the primary topic of that message or item to become the selected common topic. Other message features or document features (or other content items) having a primary topic that is the same as the selected common topic are provided with the visual indicator. In the example, the visual indicator present is a boldness of an item interface element 312 and/or a message 318. However, coloration, font size, highlighting, or other emphases can also be used in practice.

FIG. 3B illustrates a second GUI 302. In the example, the second GUI 302 includes a first GUI element 320. A second GUI element 325 within the first GUI element 320 presents an item history in the form of a timeline of content items. In the example, a first content item is presented in a first item interface 330, and a second content item is presented in a second item interface 350. The first content item includes at least a first feature interface 340. The second content item includes at least a second feature 355. As the user scrolls down to view subsequent content items, content items with a primary topic matching the selected common topic are presented (content items 357A, 357B, in the example).

In the example of FIG. 3B, one or more assets are generated by the system and presented adjacent to the first item interface 330. In the example shown the assets include a subject asset 331, an action item asset 333A, a work item asset 333B, and a document asset 333C. Assets of various types, such as action item, work item, alert, summary, suggestion, and/or item types or links are generated and/or presented in various embodiments.

The subject asset 331 provides an identification and/or summary of a subject. The subject asset 331 includes a subject icon 332 displaying an image associated with the subject or a subject profile. In various embodiments, the subject asset 331 includes an address, contact information, and/or condition. In an example, a subject is a medical patient with multiple conditions, and a name for a condition for which the topic of the conversation history is associated is shown with an icon and a name for the patient.

In the example, the action item asset 333A includes an action item label 334A, an action icon 337A, and an action button 339A. The action item label 334A includes text indicating a particular action associated with executing the action item. The action icon 337A is a picture or image associated with the particular action, with executing the action item, and/or with a topic related to the action item. The action button 339A is an interface displaying text or an image. A user can execute the action item by clicking or otherwise interacting with the action button 339A.

In the example, the work item asset 333B includes a work item label 334B, a work item icon 337B, and a work item action button 339B. The work item label 334B includes text indicating a particular work item generated if the work item action button 339B is pressed. The work item icon 337B is a picture or image associated with the work item and/or a topic related to the work item. The work item action button 339B is an interactive element displaying text or an image. A user automatically generates a draft work item document by clicking or otherwise interacting with the action button 339B.

In the example, the document asset 333C includes document asset label 334C, document asset icon 337C, and document asset link button C. The document asset label includes text indicating a particular document name for which a detail view is generated and/or present if the document asset action button 339C is pressed. The document asset icon 337C is a picture or image associated with the document asset and/or a topic related to the document asset. The document asset action button 339C is an interactive element displaying text or an image. A user automatically generates and/or is presented with a detailed view of the document by clicking or otherwise interacting with the action button 339C.

In FIG. 3B, the first feature interface 340 of the first item interface 330 is presented with a visual indicator indicating that a feature associated with the first content item has been selected. In some embodiments, the primary topic of the selected feature becomes a selected common topic. The second content item is presented with a visual indicator in the second item interface 350 indicating that a topic associated with the second content item is the same as the selected common topic.

In the example, one or more action item assets 333A are generated and/or presented adjacent to an edge of the first item interface 330. In the example, the first feature interface 340 includes a first feature for which an included or related topic of the first feature matches a primary topic of the second item interface 350. A feature of item B, such as a summary, excerpt, image, message portion, or other feature, is identified based on belonging to a same cluster as the first feature of the first feature interface 340.

For example, the second feature 355 is a test result, chart, or graph contained in a document. Responsive to the second feature being identified as belonging to a same cluster as the first feature and/or having a highest closeness to the first feature, the action item asset 333A is generated and/or presented. Thus, action items assets are generated based on selected features of the item for the first topic. In the example, although the second feature has a different primary topic, it is a feature of the second item (Item B) that is a member of the same cluster as the first item (or another selected item). If the user indicates another item or feature of an item having a different primary topic, different assets are generated and/or presented based on the different primary topic. Alternatively, a different content item timeline is generated, and/or an item detail view is generated and/or presented in response to a user indication. Content items are determined using clusters based on the feature indicated by the user. These content items are presented in the timeline according to timestamp, topic, user, source, sender, recipient, or the like.

FIG. 3C illustrates a third GUI 303. In FIG. 3C, the third GUI 303 includes a first GUI element 360 containing an item detail element 370, an item detail view 380, and a conversation history element 390.

The item detail view 380 included in the item detail element 370 displays a plurality of assets, including a subject asset 381, an action item asset 383A, a work item asset 383B, and a document asset 383C. The assets 383A, 383B, and 383C are arranged in the item detail element 370 adjacent to one or more edges of the item detail view 380. In the example, the subject asset 381 includes a subject icon 382. In examples, the subject asset 381, assets 383A, 383B, 383C, and/or any other assets, optionally include one or more labels, icons, buttons, or other informative or interactive elements.

The item detail view 380 displays the full details of a content item. For example, the item detail view displays the features of a document or displays the features of a message. In the example, the patient asset 381, action item asset 383A, work item asset 383B, and document asset 383C are generated and/or displayed responsive to one or more topics of the item. Furthermore, if the system determines a topic is associated with a patient condition, the condition is shown in the patient asset 381. The system also determines one or more action items, work items, and/or documents related to the topic. The system generates and presents assets for the items related to the topic. Thus, message content items and non-message content items are presented in the heterogeneous content history timeline view.

In the example, an item type label 362, an item name label 364, and an action button 366 are displayed in the first graphical interface element in association with item detail element 370 and the conversation history element 390. The item type label 362 provides information describing the item type (i.e., conversation, thread, chart, result, summary, diagnosis, condition), and the item name label 364 provides an information describing a name for the item (i.e., conversation A, thread A, chart A, result A, summary of event A, diagnosis A, condition A). One or more action buttons perform navigation and/or confirmation functions. For example, the action button 366 contracts the item detail view and/or results in navigating the user to another GUI, such as first GUI 301 or second GUI 302.

The conversation history element 390 includes an information box 395 and a text input field 397. The conversation history element 390 displays portions 393 of messages related to the topic of the item for which the detail view is active. Portions 393 of messages are extracted and arranged in conversations related to the topic. The message information box 395 provides message information, such as sender, recipient, timestamp, and/or subject line. The message body includes one or more message portions 393. In embodiments, portions 393 are whole messages and/or extracted portions of messages related to the primary topic for the active detail view.

The conversation history element 390 includes a display of a timeline of messages and/or threads associated with a primary topic. For example, when an item is selected from a GUI, a primary topic for the item is determined. Sections of messages related to the topic are extracted and presented in the timeline. Extracted portions are clustered together by thread or conversation.

The conversation history element 390 includes message information box 395 and a text input field 397. The message information includes one or more of a sender, recipient, subject line, date, timestamp, previous messages, and/or other information. The text input field 397 receives input text from a user. In some embodiments, the input text is sent to another user via instant message, direct message, or email, or is uploaded and/or otherwise transmitted to a forum or message center.

In various embodiments, other configurations of GUI elements presenting content items, assets, messages, documents, other content items, and/or extracted features of content items are generated and/or presented to a user.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (“HTTP”). The requests are communicated through an interface, such as a client interface (such as a web browser), a program interface, or an application programming interface (“API”).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a heterogeneous content management engine a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a heterogeneous content management engine may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a heterogeneous content management engine to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (“IFTTT”), Zapier, or Oracle Self-Service Automation (“OSSA”)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (“ASICs”), field programmable gate arrays (“FPGAs”), or network processing units (“NPUs”) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

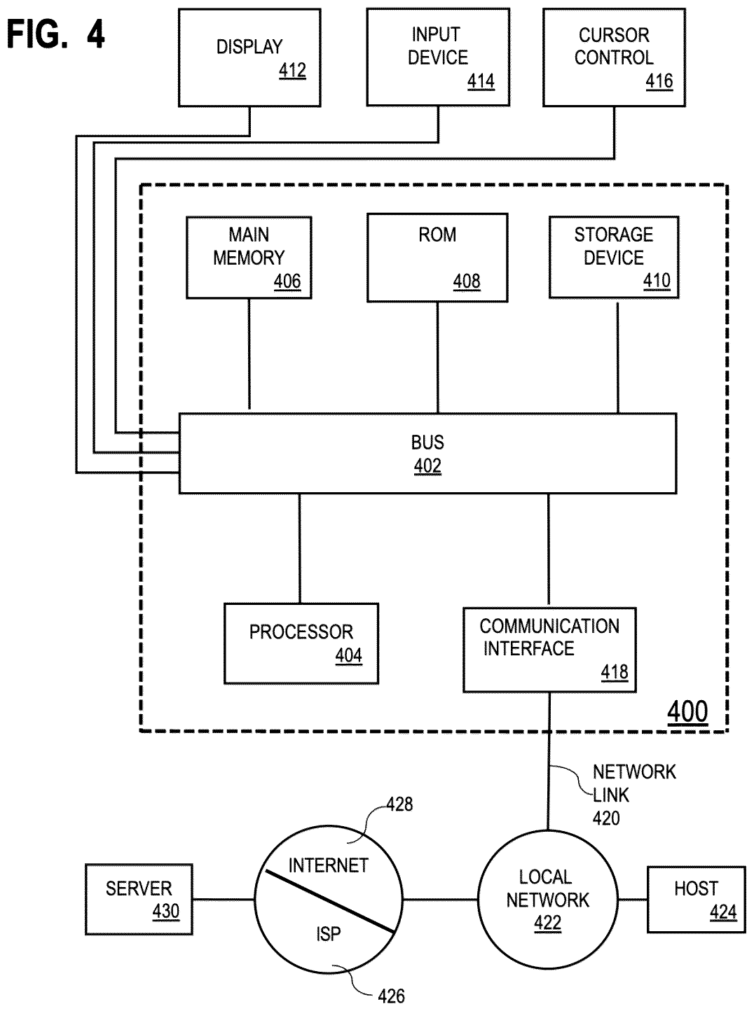

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (“RAM”) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (“ROM”) 408 or other static storage device coupled to bus 402 for storing static information and instructions for processor 404. A storage device 410, such as a magnetic disk, optical disk, or a Solid State Drive (“SSD”) is provided and coupled to bus 402 for storing information and instructions.

Computer system 400 may be coupled via bus 402 to a display 412, such as a cathode ray tube (“CRT”), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory “(CAM”), and ternary content-addressable memory (“TCAM”).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (“ISDN”) card, cable modem, satellite modem, or a modem to provide a data communication connection to a corresponding type of telephone line. As another example, communication interface 418 may be a local area network (“LAN”) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (“ISP”) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions; Other Considerations

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing a heterogeneous plurality of content items comprising (a) messages and (b) non-message content items;
determining respective topics associated with the heterogeneous plurality of content items;
clustering the heterogeneous plurality of content items into a plurality of clusters based on the respective topics associated with the heterogeneous plurality of content items, wherein:
the plurality of clusters comprises a first cluster,
the first cluster comprises a first subset of the heterogeneous plurality of content items that correspond to a first topic, and
the first subset of the heterogeneous plurality of content items comprises at least one message and at least one non-message content item;
based on one or more timestamps associated with the at least one message and the at least one non-message content item: arranging the first subset of the heterogeneous plurality of content items to generate a first ordered list of content items corresponding to the first topic;
responsive at least to receiving a request to present content items corresponding to the first topic, displaying at least a portion of the first ordered list of content items corresponding to the first topic, wherein the portion of the first ordered list comprises the at least one message and the at least one non-message content item.

2. The non-transitory media of claim 1, the operations further comprising:
clustering the heterogeneous plurality of content items comprises (a) using a first clustering criteria for the messages comprised in the heterogeneous plurality of content items and (b) using a second clustering criteria for the non-message content items comprised in the heterogeneous plurality of content items.

3. The non-transitory media of claim 1, the operations further comprising:
extracting a first message portion from a first message in the first subset of the heterogeneous plurality of content items based on the first message portion corresponding to the first topic;
extracting a second message portion from a second message in the first subset of the heterogeneous plurality of content items based on the second message portion corresponding to the first topic; and
displaying the first message portion and the second message portion in an order that corresponds to timestamps associated respectively with the first message and second message.

4. The non-transitory media of claim 1, wherein:
a source for the messages is a message center and the source for the non-message content items is a document management system.

5. The non-transitory media of claim 1, the operations further comprising:
extracting a first portion of a first message based on the first portion being associated with the first topic; and
extracting a second portion of a second message based on the second portion being associated with the first topic.

6. The non-transitory media of claim 1, wherein
a particular timestamp of the one or more timestamps associated with a particular non-message content item of the first subset of the heterogeneous plurality of content items corresponds to at least one of: a date of creation of the particular non-message content item and a date of receipt of the particular non-message content item; and
a particular message timestamp associated with a particular message of the first subset of the heterogeneous plurality of content items corresponds to a transmission time of the particular message.

7. The non-transitory media of claim 1, wherein
the first ordered list of content items corresponding to the first topic is ordered by timestamps associated with the first subset of the heterogeneous plurality of content items, including a first timestamp for a message and a second timestamp for a non-message content item.

8. The non-transitory media of claim 1, wherein:
clustering the plurality of content items into the first cluster comprises determining the first subset of the heterogeneous plurality of content items belongs to the first cluster using a weighted scoring of at least one of a source, a topic, and a timestamps for the first subset of content items.

9. The non-transitory media of claim 1, the operations further comprising:
organizing the subset of the plurality of content items within the first cluster by arranging the subset with a plurality of source indicators in an order defined by a plurality of timestamps for the subset.

10. The non-transitory media of claim 1, wherein:
clustering the plurality of content items comprises clustering a first content item and a second content item into the first cluster based on a minimum score for at least one of a minimum topical correlation value and a minimum temporal correlation value for the first content item and the second content item.

11. The non-transitory media of claim 1, wherein:
the plurality of clusters comprises a second cluster;
the second cluster comprises a second subset of the heterogeneous plurality of content items that correspond to a second topic; the operations further comprising:
accessing a set of topics associated with content items included in the first cluster, the set of topics including the first topic and the second topic;
in response to an indication of the second topic, arranging the second subset of the heterogeneous plurality of content items to generate a second ordered list of content items corresponding to the second topic; and
displaying at least a portion of the second ordered list of content items corresponding to the second topic.

12. The non-transitory media of claim 1, the operations further comprising:
responsive to an indication of a particular non-message content item, clustering a second subset of the plurality of content items into a second cluster associated with one or more primary topics of the non-message content item.

13. The non-transitory media of claim 1, the operations further comprising:
responsive to receiving a particular non-message content item associated with a particular topic related to a work item request, generating a draft work item using one or more portions extracted from a particular subset of the plurality of content items associated with the particular topic.

14. The non-transitory media of claim 1, the operations further comprising:
displaying the at least one message and the at least one non-message content item.

15. The non-transitory media of claim 1, wherein
the non-message content items comprise at least one of: a chart; a test result; a recommendation; and a document.

16. The non-transitory media of claim 1, wherein
a first correlation value threshold is used to determine cluster membership for messages and a second correlation value threshold is used to determine cluster membership for non-message content items, the first correlation value indicating a first correlation between a message and a topic, and the second correlation value indicating a second correlation between a non-message content item and the topic.

17. The non-transitory media of claim 1, the operations further comprising:
responsive to a threshold number of messages associated with a particular cluster referencing a particular non-message content item, adding the particular non-message content item to the particular cluster.

18. The non-transitory media of claim 1, the operations further comprising:
responsive to a triggering condition related to a content item of the first subset:
generating an asset based on the content item; and
presenting the asset in association with the content item in the first ordered list of content items corresponding to the first topic.

19. A system comprising:
at least one device including a hardware processor;
the system being configured to perform operations comprising:
accessing a heterogeneous plurality of content items comprising (a) messages and (b) non-message content items;
determining respective topics associated with the heterogeneous plurality of content items;
clustering the heterogeneous plurality of content items into a plurality of clusters based on the respective topics associated with the heterogeneous plurality of content items, wherein:
the plurality of clusters comprises a first cluster,
the first cluster comprises a first subset of the heterogeneous plurality of content items that correspond to a first topic, and
the first subset of the heterogeneous plurality of content items comprises at least one message and at least one non-message content item;
based on one or more timestamps associated with the at least one message and the at least one non-message content item: arranging the first subset of the heterogeneous plurality of content items to generate a first ordered list of content items corresponding to the first topic;
responsive at least to receiving a request to present content items corresponding to the first topic, displaying at least a portion of the first ordered list of content items corresponding to the first topic.

20. A method comprising:
accessing a heterogeneous plurality of content items comprising (a) messages and (b) non-message content items;
determining respective topics associated with the heterogeneous plurality of content items;
clustering the heterogeneous plurality of content items into a plurality of clusters based on the respective topics associated with the heterogeneous plurality of content items, wherein:
the plurality of clusters comprises a first cluster,
the first cluster comprises a first subset of the heterogeneous plurality of content items that correspond to a first topic, and
the first subset of the heterogeneous plurality of content items comprises at least one message and at least one non-message content item;
based on one or more timestamps associated with the at least one message and the at least one non-message content item: arranging the first subset of the heterogeneous plurality of content items to generate a first ordered list of content items corresponding to the first topic;
responsive at least to receiving a request to present content items corresponding to the first topic, displaying at least a portion of the first ordered list of content items corresponding to the first topic, wherein
the method is performed by at least one device including a hardware processor.
